(19) United States
(12) Patent Application Publication
(10) Pub. No.: US 2011/0094287 A1
(43) Pub. Date: Apr. 28, 2011

(54) SYSTEM AND METHOD FOR AUTOMATED CALIBRATION OF A FUEL FLOW METER IN A FUEL DISPENSER

(75) Inventors: Seifollah S. Nanaji, Hinsdale, IL (US); John Steve McSpadden, Kernersville, NC (US); Gordon Wayne Johnson, Stokesdale, NC (US)

(73) Assignee: Gilbarco Inc., Greensboro, NC (US)

(21) Appl. No.: 12/983,690

(22) Filed: Jan. 3, 2011

Related U.S. Application Data
(62) Division of application No. 11/757,019, filed on Jun. 1, 2007, now abandoned.

(51) Int. Cl. G01F 25/00

(52) U.S. Cl. 73/1.36

(57) ABSTRACT

Methods, systems, and computer program products for using a reference meter to provide automated calibration for a fuel dispenser are disclosed. According to one method, first historical metering data associated with a fuel flow meter and second historical metering data associated with a reference meter are maintained within a memory. The first historical metering data is compared with the second historical metering data. It is determined whether a difference exists between the first historical metering data and the second historical metering data that can be corrected by calibration of the fuel flow meter. In response to determining that a difference exists between the first historical metering data and the second historical metering data that can be corrected by calibration of the fuel flow meter, an automated calibration of the fuel flow meter is performed.

### CLAIM OF PRIORITY

This application is a divisional application of and claims priority to U.S. patent application Ser. No. 11/757,019, filed Jun. 1, 2007, the entire disclosure of which is hereby incorporated by reference for all purposes as if set forth verbatim herein.

### FIELD OF THE INVENTION

The present invention relates to a system and method for automated calibration of a fuel flow meter in a fuel dispenser using a reference meter.

### BACKGROUND OF THE INVENTION

Fuel dispensers dispense petroleum and alternative fuel products at retail service stations and fueling environments and convenience store operations around the world. Regulations require that fuel dispensers accurately dispense fuel within strict volumetric tolerances. In this regard, fuel dispensers employ fuel flow meters that measure the amount of fuel delivered to a customer's vehicle and charged to the customer. In addition to regulatory requirements governing the accuracy of fuel flow meters, inaccurate fuel dispensing transactions can generate significant losses for retail fuel dispenser operators in the form of lost profits and increased costs associated with dispensed fuel products.

One type of fuel flow meter that is commonly used within a fuel dispenser to measure fuel delivered to a vehicle is a positive displacement meter (PDM). PDMs measure fuel delivered by measuring the amount of displaced fuel within a known-volume container within the meter. PDMs are also used in a variety of other fluid dispensing environments. PDMs are reasonably priced and, when calibrated properly, are capable of accurately metering fuel transactions across a broad range of fuel flows that occur within a retail fueling environment.

However, PDMs may include dynamic seals which experience wear and leak over time. Additionally, the displacement volume increases within the cylinder bore of a PDM over time due to wear and sediment buildup. These factors result in a change in accuracy for a PDM over time. This change in accuracy is known as “drift” and results in inaccurate meter readings for the PDM. For example, as a cylinder in a PDM wears over time, the displacement within the cylinder of the PDM increases. The increased displacement results in a larger volume within the cylinder and this larger volume results in more fuel being dispensed for a given fuel dispenser transaction than is measured by the PDM. The unmeasured fuel translates into lost profits and increased costs during fuel dispensing transactions. Further, as a meter drift increases prior to calibration, the rate at which profits are lost also increases.

In order to prevent or reduce the effect of meter drift, PDMs must be periodically calibrated to adjust for the drift that results from the bearing wear, dynamic seal wear, sediment buildup, and cylinder wear within the PDMs. Calibration must be performed frequently enough to maintain the accuracy of the fuel flow meter within regulated limits.

Calibration may be performed for a PDM by changing an electronic calibration factor associated with the PDM that defines the volumetric value of a pulse train generated by a rotary encoder attached to a rotating shaft within the PDM representative of the displacement volume. This pulse train is received by an electronic control system within the fuel dispenser electronics and is converted into a volumetric value representing the volume dispensed by the PDM. Periodic calibration provides a periodic adjustment of the electronic calibration factor for the given PDM.

This required periodic calibration is performed within conventional fuel dispensing systems manually, which adds an additional maintenance expense to each conventional fuel dispenser produced. This additional maintenance expense is incurred throughout the life of the dispenser. These maintenance fees associated with periodic calibration can be significant over time. Accordingly, calibration schedules are typically selected in order to balance the lost profits that result from drift with the expense of calibrating a fuel dispenser. Additionally, conventional fuel dispenser operators pay the maintenance fees and have become accustomed to considering them as a cost of doing business.

FIG. 1 illustrates an exemplary characteristic curve for a typical PDM. The horizontal axis represents a flow rate in gallons per minute (GPM), and the vertical axis represents percent error in the metered fuel transaction. The data represented by the characteristic curve correlates the percent error with various flow rates within the PDM. As such, the characteristic curve quantifies the percent error for a given PDM over the flow rate range of operation for the PDM. The percent error may then be used to adjust metered quantities for the PDM based upon the flow rate measured throughout a fuel dispenser transaction.

The electronic calibration factor for any given volume of fuel flow may be obtained from the characteristic curve. As can be seen from FIG. 1, the characteristic curve represented within the flow range illustrated is relatively flat. A term known as “spread” characterizes the variance of a meter error percentage across flow rates for a meter. The spread for a given meter may be relatively flat or may be dynamic over an operating range for the given meter. The characteristic represented within FIG. 1 may be considered a “flat spread” for purposes of the description herein. PDMs generally have a flat spread.

As described above, the displacement within the cylinder of a PDM increases over time due to wear within the cylinder and is known as drift. This increase will typically result in a constant and positive change over the entire range of operation for the PDM, thereby maintaining the relatively flat spread for the PDM over time. Accordingly, periodic adjustments to the characteristic curve are required in order to correct the PDM output. As a result, a calibration operation typically adjusts the characteristic curve for the PDM upward to account for drift within the PDM.

Several factors can affect the fluid that flows through a PDM. These factors include pressure pulsations, flow fluctuations, rapid temperature swings in the metered fluid, rapid viscosity and density changes within the metered fluid, the presence of events that disturb the flow profile of the fluid such as water hammer effects associated with multiple nozzle snaps by a customer, and other related factors. A properly calibrated PDM can typically meter fuel under these conditions. However, a PDM may not be able to detect issues that would require stoppage of the fuel dispenser. For example, a proportional valve problem may not be detectable by use of a PDM.

Accordingly, there exists a need to provide automated calibration of a fuel flow meter in a fuel dispenser to automatically adjust for meter drift that may occur from time to time.

### SUMMARY OF THE INVENTION

The present invention places a reference meter in the flow path of a fuel flow meter within a fuel dispenser to automatically calibrate the fuel flow meter. The fuel flow meter is used to accurately measure fuel flow delivered to a vehicle and charged to a customer. However, the fuel flow meter may be subject to meter drift requiring periodic calibration. The reference meter is a meter that does not typically experience meter drift and, if experienced, would be less than a typical fuel flow meter. As the fuel flow meter drifts, a control system associated with the fuel dispenser detects the drift by comparing fuel flow measurements taken from the fuel flow meter and the reference meter when fueling conditions are in a stable state, meaning the reference meter measurements are highly accurate. The control system uses the reference meter measurements either in real-time or at a later time to calibrate the fuel flow meter in an automated fashion by adjusting a calibration factor associated with the fuel flow meter. The calibration factor may be an electronic factor that is stored in the fuel flow meter or in an electronic control system that converts measurements from the fuel flow meter to volume.

By use of the present invention, calibration may be performed more often than in conventional systems and may be performed automatically without manual intervention. Accordingly, lost profits and maintenance expenses may be reduced.

In one exemplary embodiment, a reference meter is placed in the fuel flow path where fuel flow converges from three fuel flow meters that independently meter three different grades of fuel within a fuel dispenser. As a selected grade of fuel is dispensed, fuel flows through the fuel flow meter associated with the selected grade of fuel and flows through the reference meter in route to the dispenser hose and the customer's vehicle. A control system detects periods of stable fuel flow and takes measurements from the reference meter and the fuel flow meter. The measurements may be saved to memory to form historical metering data for the meters. The control system may compare either the real-time measurements or the historical metering data for the reference meter and the fuel flow meter to determine whether a difference exists that indicates drift has occurred in the fuel flow meter. Upon determining that drift in the fuel flow meter associated with the selected grade has occurred, the control system uses the measurements taken from the reference meter to automatically calibrate the fuel flow meter.

In another exemplary embodiment, a reference meter is placed in the fuel flow path where fuel flow converges from two fuel flow meters that independently meter two different pure grades of fuel within a blending fuel dispenser. Blending fuel dispensers dispense both high-octane fuel and low-octane fuel during blending transactions and dispense pure high- or low-octane fuel during the respective pure fuel transactions. In this exemplary embodiment, blended transactions may be ignored for calibration purposes. Transactions that involve pure grades of fuel provide metering data that can be used for calibration purposes because fuel that flows through the respective fuel flow meter also flows through the reference meter without being diluted by the other pure blend. Automated calibration of the fuel flow meters can be performed based upon measurements taken during pure fuel dispenser transactions as described above and in more detail below. The present invention is not limited to positive displacement meter types.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 illustrates an exemplary characteristic curve of a positive displacement fuel flow meter according to an embodiment of the present invention;

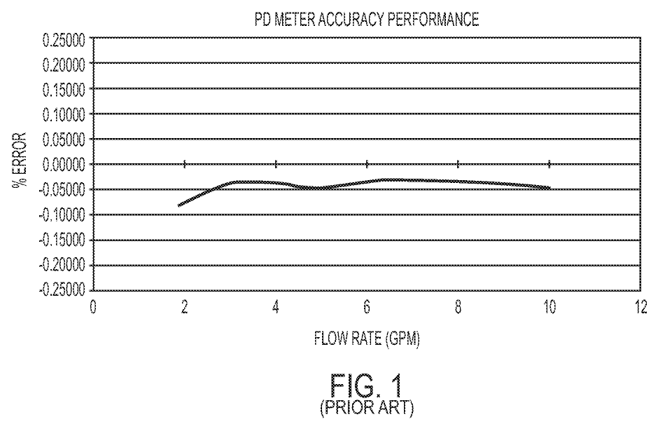

FIG. 2 illustrates an exemplary fuel dispenser capable of automated calibration of a fuel flow meter using a reference meter according to an embodiment of the present invention;

FIG. 3 is a block diagram illustrating more detail of a control system for a fuel dispenser capable of automated calibration of a fuel flow meter according to the embodiment of the present invention illustrated in FIG. 2;

FIG. 4 is a flow chart illustrating an exemplary process for a fuel dispenser transaction providing for the storage of fuel flow measurement information that may be used during an automated calibration operation of the fuel flow meter according to the present invention;

FIG. 5 is a flow chart illustrating an exemplary process for automated calibration of a fuel flow meter based on stored fuel flow measurements according to an embodiment of the present invention; and

FIG. 6 illustrates an exemplary blending fuel dispenser capable of automated calibration of a fuel flow meter using a reference meter according to an embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention places a reference meter in the flow path of a fuel flow meter within a fuel dispenser to automatically calibrate the fuel flow meter. The fuel flow meter is used to accurately measure fuel flow delivered to a vehicle and charged to a customer. However, the fuel flow meter may be subject to meter drift requiring periodic calibration. The reference meter is a meter that does not typically experience meter drift and, if experienced, would be less than a typical fuel flow meter. As the fuel flow meter drifts, a control system associated with the fuel dispenser detects the drift by comparing fuel flow measurements taken from the fuel flow meter and the reference meter when fueling conditions are in a stable state, meaning the reference meter measurements are highly accurate. The control system uses the reference meter measurements either in real-time or at a later time to calibrate the fuel flow meter in an automated fashion by adjusting a calibration factor associated with the fuel flow meter. The calibration factor may be an electronic factor that is stored in the fuel flow meter or in an electronic control system that converts measurements from the fuel flow meter to volume.

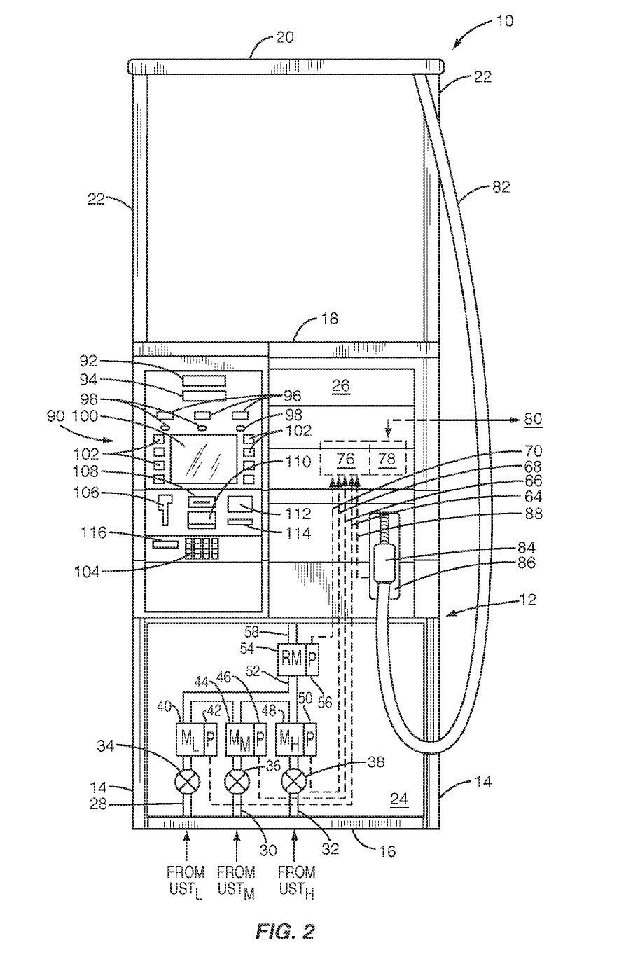

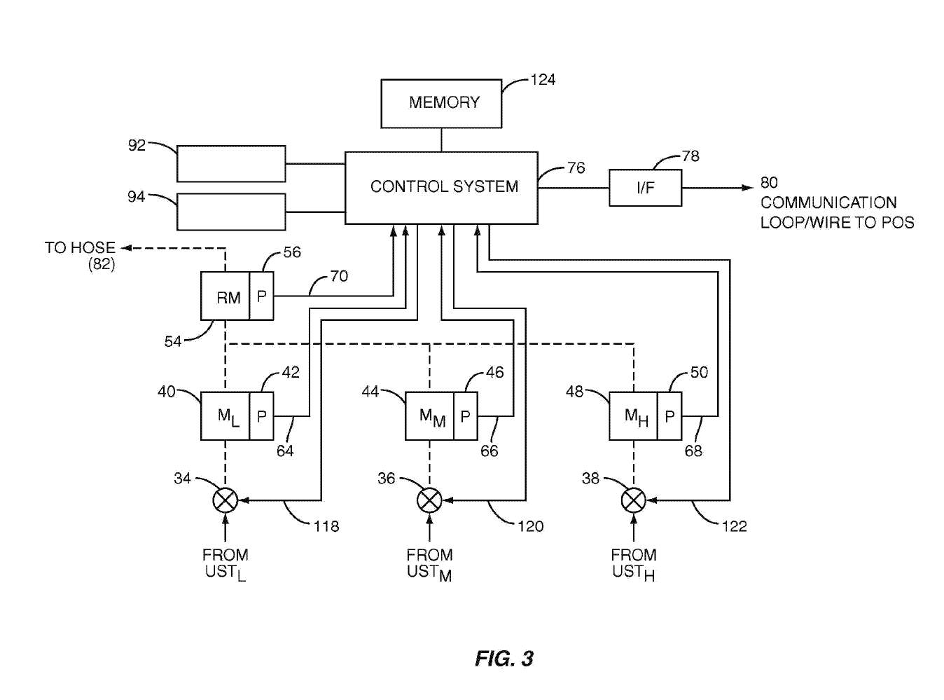

Before discussing the particular aspects of how the reference meter obtains fuel flow measurements to perform automated calibration of the fuel flow meter, the basic components of an exemplary fuel dispenser and its control system employing fuel flow meters and a reference meter are first described with respect to FIGS. 2 and 3 herein.

FIG. 2 illustrates an exemplary embodiment of a fuel dispenser 10 capable of automated calibration of a positive displacement meter (PDM) according to an embodiment of the invention described herein. The fuel dispenser 10 includes a housing 12 with two sides 14. The fuel dispenser 10 has a base 16 and a top 18, with a canopy 20 supported by two side panels 22.

The fuel dispenser 10 is subdivided into multiple compartments. A hydraulic area 24 may be used to enclose hydraulic components and an electronic area 26 may be used to enclose electronic components. A vapor barrier (not shown) may be used to separate hydraulic area 24 from electronic area 26.

Several components used to control fuel flow may be housed within hydraulic area 24. Fuel from the underground storage tanks (USTs-not shown) is pumped through a piping network into inlet or fuel dispensing pipes. An inlet pipe 28 provides a piping network from a low-octane UST (UST_{L}), an inlet pipe 30 provides a piping network from a medium-octane UST (UST_{M}), and an inlet pipe 32 provides a piping network from a high-octane UST (UST_{H}).

A flow control valve 34 controls fuel flow from the UST_{L}, while a flow control valve 36 and a flow control valve 38, control fuel flow from the UST_{M} and the UST_{H}, respectively. Fuel may begin to flow from the respective UST when any of the flow control valves 34, 36, or 38 is opened. The flow control valves 34, 36, or 38 are controlled by a control system 76, as will be described in more detail below.

When the flow control valve 34 is opened by control system 76, fuel begins to travel through a PDM M_{L} 40, which is responsive to flow rate or volume. A pulser 42 may be employed to generate a signal in response to fuel movement through meter M_{L} 40. Similarly, when either the flow control valve 36 or 38 is opened by control system 76, fuel begins to travel through either a PDM M_{M} 44 or a PDM M_{H} 48, respectively. Meter M_{M} 44 has a pulser 46 and meter M_{H} 48 has a pulser 50, each of which may also be employed to generate a signal in response to fuel movement through the respective meter 40, 44, 48.

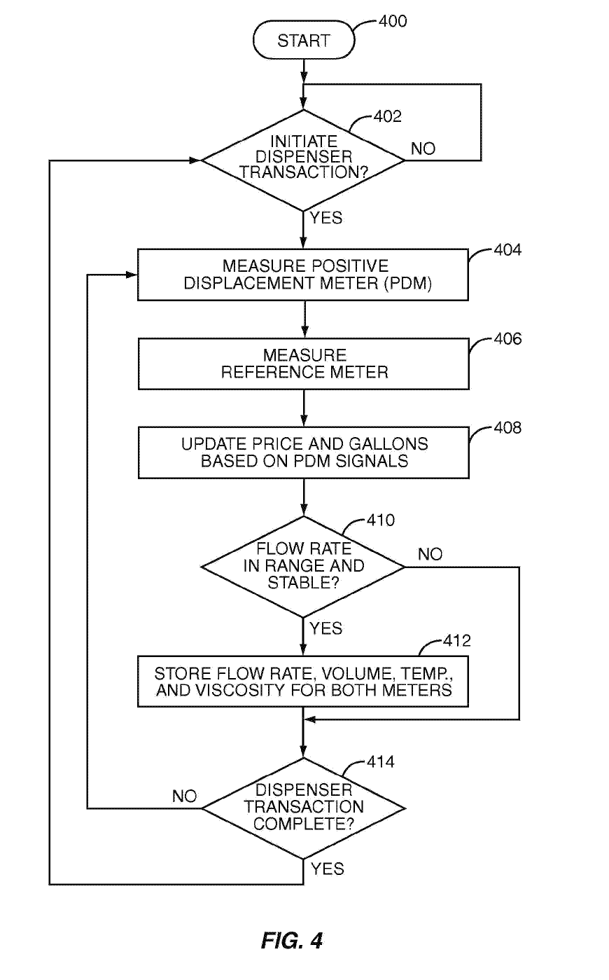

Fuel flow from the PDMs 40, 44, 48 typically converges within a manifold 52. The manifold 52 routes fuel flow through a reference meter (RM) 54 with an associated pulser 56. As described above, RM 54 does not typically experience meter drift. Accordingly, measurements taken from RM 54 may be used by control system 76 to automatically calibrate the PDMs 40, 44, 48. Because the RM 54 is known to be highly accurate, a comparison of the fuel flow measurements between the RM 54 and the PDMs 40, 44, 48 will indicate whether the PDMs 40, 44, 48 have drifted. In such a case, the fuel flow measurement from the RM 54 is taken to be the correct fuel flow measurement and is used to automatically calibrate the PDMs 40, 44, 48. More information on the process of collecting fuel flow measurement data and automatically calibrating fuel flow meters, such as the PDMs 40, 44, 48 using the RM 54 will be described in more detail below, starting with FIG. 4.

The RM 54 may be a higher-cost PDM, an inferential meter, or any type of meter that is capable of accurately measuring fuel flow and is either less prone or not prone to meter drift. For example, the inferential meter may be a single turbine or dual turbine rotor inferential meter like that described in U.S. Pat. No. 5,689,071, incorporated herein by reference in its entirety. In either case, the RM 54 may be used to provide calibrated measurement results and may not be susceptible to drift and other conditions associated with typical PDMs as described above. The RM 54 may provide calibration capabilities to the fuel dispenser 10 by performing data gathering associated with fuel flow through the PDMs 40, 44, 48 to provide data reference measurements. Details specific to use of an inferential meter as a reference meter and of the remaining elements of FIG. 2 will be described after the following high-level description of fuel flow measurement within a fuel dispenser, such as fuel dispenser 10. However, more description of the fuel dispenser 10 and its control system are further described below with respect to FIGS. 2 and 3.

The fuel to be delivered may flow from RM 54 via an outlet pipe 58 during a fuel dispensing transaction. A data line 64 provides a signaling path from pulser 42 to the control system 76. Data line 64 may provide signals to the control system 76 indicative of the flow rate or volume of fuel being dispensed within meter M_{L} 40. A data line 66 likewise provides a signaling path from pulser 46 to control system 76. Similarly, a data line 68 and a data line 70 provide signaling paths from pulsers 50 and 56, respectively, to control system 76.

As fuel is dispensed from the fuel dispenser 10, the control system 76 receives signaling from pulsers associated with the meters described above that are involved with the dispensing transaction. In response to receipt of signaling from the pulsers 42, 46, 50, the control system 76 may provide transaction-level and calibration control functionality within the fuel dispenser 10. The control system 76 collects meter flow measurements, performs calibration operations associated with PDMs M_{L} 40, M_{M} 44, and M_{H} 48, and performs calculations such as cost associated with a fuel dispensing transaction.

Additionally, the control system 76 may provide external communication capabilities for the fuel dispenser 10 via an interface 78 to a remote terminal 80. The remote terminal 80 may be used to collect information from multiple fuel dispensers, such as fuel dispenser 10. The remote terminal 80 may also be used for status information reporting associated with calibration activities and meter problems.

As a dispensing transaction progresses, fuel is then delivered from the outlet pipe 58 to a hose 82 and through a nozzle 84 into the customer's vehicle (not shown). The fuel dispenser 10 includes a nozzle boot 86, which may be used to hold and retain the nozzle 84 when not in use. The nozzle boot 86 may include a mechanical or electronic switch (not shown) to indicate when the nozzle 84 has been removed for a fuel dispensing request and when the nozzle 84 has been replaced, signifying the end of a fueling transaction. A control line 88 provides a signaling path from the electronic switch to the control system 76. The control system 76 uses signaling received via the control line 88 in order to make a determination as to when a fueling transaction has been initiated or completed.

The fuel dispenser 10 also includes a user interface 90 to allow a user/customer to interact with and control a dispenser transaction at the fuel dispenser 10. The user interface 90 includes a variety of input and output devices and also includes a transaction price total display 92 that may be used to present the customer with the price to be charged to the customer for fuel. The user interface 90 also includes a transaction gallon total display 94 that may be used to present the customer with the measurement of fuel dispensed in units of gallons or liters as a volume of fuel dispensed from the fuel dispenser 10.

The fuel dispenser 10 illustrated in FIG. 2 is a multi-product dispenser that is capable of dispensing different grades of fuel. The price-per-unit (PPU) for each grade of fuel is displayed on displays 96. Octane selection buttons 98 are provided for the customer to select which grade of fuel is to be dispensed before dispensing is initiated.

The user interface 90 may also include a large display screen 100 that may be used to provide instructions, prompts, and/or advertising or other information to the customer. Customer selections may be made in response to prompts on the display screen 100 by use of soft keys 102 or keys on a keypad 104. The soft keys 102 may be designed to align proximate prompts for the customer to indicate his or her desired choice in response to a question or request. The fuel dispenser 10 may also include a card reader 106 that is adapted to receive a magnetic stripe card, such as a credit or debit card, for payment of fuel dispensed. The fuel dispenser 10 may further include other payment or transactional type devices to receive payment information for transaction processing associated with fueling transactions such as a pre-paid dispenser transaction, including a bill acceptor 108, an optical reader 110, a smart card reader 112, and a biometric reader 114. The fuel dispenser 10 includes a receipt printer 116 so that a receipt with a recording of the dispensing transaction carried out at the fuel dispenser 10 may be generated and presented to the customer.

As previously described, the control system 76 may be used to collect metering measurements from the pulsers 42, 46, 50 associated with the meters 40, 44, 48 within fuel dispenser 10 and for communication purposes with the remote terminal 80 via use of the interface 78. The control system 76 also controls the user interface 90 during fuel dispensing transactions.

It should be noted that multiple reference meters may be used within the fuel dispenser 10 without departing from the scope of the subject matter described herein. Accordingly, a reference meter may be placed at a location associated with each PDM 40, 44, 48. However, because only one grade of fuel is dispensed during any transaction within a non-blended dispenser, a single reference meter may provide the most cost-effective calibration capabilities for the fuel dispenser 10.

For the case of a blended fuel dispenser, as with non-blended dispensers, either multiple or single reference meters may be used. However, in the case of a single reference meter, statistical sampling of calibration-related data may be performed when a pure product (e.g., low-octane or high-octane) is dispensed rather than during blended transactions.

FIG. 3 illustrates the control system 76 in more detail for purposes of describing portions of the control system 76 associated with the control of components within the fuel dispenser 10 during a fueling transaction and during an automated calibration of a PDM within the fuel dispenser 10 according to an embodiment of the subject matter described herein.

The transaction price total display 92 and the transaction gallon total display 94 are illustrated within FIG. 4 for purposes of illustrating exemplary connectivity with components within the user interface 90 (not shown in FIG. 4). For purposes of illustration, other components within the user interface 90 are not illustrated within FIG. 4. Likewise, the interface 78 is illustrated with a reference to the remote terminal 80 in order to provide exemplary connectivity for signaling purposes at the interface 78.

Fuel flows from UST_{L}, UST_{M}, and UST_{H} are illustrated within FIG. 4 by the use of dashed lines and arrows entering the flow control valves 34, 36, and 38, respectively. Dashed lines further represent fuel flow from the flow control valves 34, 36, 38 through the PDMs M_{L} 40, M_{M} 44, and M_{H} 48 of the fuel dispenser 10. As can be seen from FIG. 3, as fuel flows through any of the PDMs 40, 44, 48 within the fuel dispenser 10, the flow continues through the RM 54 and then to the hose 82, ultimately to be deposited in the customer's vehicle.

FIG. 3 includes three control lines not illustrated in FIG. 2. A control line 118 provides a signaling path from the control system 76 to the flow control valve 34. The control line 118 may be used by the control system 76 to control the opening and closing of the flow control valve 34. Accordingly, when a fueling transaction is initiated by a customer that includes fuel from the UST_{L}, the control system 76 opens the flow control valve 34 to allow fuel to flow from the UST_{L} through PDM M_{L} 40 and RM 54 toward the hose 82. As fuel begins to flow, pulsers 42 and 56 will begin to generate signals indicative of fuel flow within the respective meters. This signaling may be provided to the control system 76 via data lines 64 and 70, respectively. The control system 76 may then perform transactional activities, such as updating the transaction price total display 92 and the transaction gallon total display 94. Further, when stable fuel flow is detected within RM 54, the control system 76 may also perform calibration-related activities, as will be described in more detail below.

Similar to the description above for the control line 118, a control line 120 and a control line 122 provide signaling paths for control of flow control valves 36 and 38, respectively. The description of activities associated with the control system 76 in relation to control line 118 applies to control line 120 and control line 122. For example, when a fueling transaction is initiated by a customer that includes fuel from the UST_{M}, the control system 76 opens the flow control valve 36 by use of signaling on the control line 120 to allow fuel to flow from UST_{M} through the PDM M_{M} 44 and RM 54 toward the hose 82. Pulsers 46 and 56 may be used to capture fuel flow measurements within the PDM M_{M} 44 and RM 54, respectively. Likewise, when a dispenser transaction is initiated by a customer that includes fuel from the UST_{H}, the control system 76 opens the flow control valve 38 by use of signaling on the control line 122 to allow fuel to flow from the UST_{H} through the PDM M_{H} 48 and RM 54 toward the hose 82. Pulsers 50 and 56 may be used to capture fuel flow measurements within the PDM M_{H} 48 and RM 54, respectively.

In addition to information related to fuel flow, such as flow rate and volume, temperature, viscosity, and other information may also be tracked within the fuel dispenser 10. A memory 124 may be used by the control system 76 to store collected data for purposes of detecting drift, problems within the PDMs 40, 44, 48, and in order to determine or predict when a PDM has gone or will go out of calibration tolerances. The memory 124 may be any volatile or non-volatile storage medium, or may be a combination of the two. The memory 124 may further include disk-based, optical, or any other storage medium suitable for a given application and may be used to store the fuel flow measurement information captured and described in relation to FIG. 4 below.

Turning to FIG. 4, an exemplary process for a fuel dispenser transaction capable of storing fuel flow measurement information for use during an automated calibration operation within a fuel dispenser is illustrated. Before the RM 54 can be used to calibrate the PDMs 40, 44, 48 in an automated fashion, measurements of the RM 54 must be obtained by the control system 76 and compared to the fuel flow measurements of the PDMs 40, 44, 48. Note that the processes described below are performed by the control system 76 in an exemplary embodiment of the present invention, but may be performed by any control system.

As illustrated in FIG. 4, the process starts (step 400), and the control system 76 may wait for a dispenser transaction to be initiated by a customer (decision 402). When a dispenser transaction is initiated, the control system 76 begins measurement operations. Next, the control system 76 samples measurement data for a positive displacement meter associated with the selected fuel grade (step 404). For example, the control system 76 may sample data associated with meter M_{L} 40. The control system 76 samples data associated with a reference meter, such as the RM 54 (step 406). The price and gallons associated with the current metered volume may be based upon the sampled measurement data for the PDM associated with the selected fuel grade (step 408).

Next, a determination is made as to whether the flow rate is within range and stable (decision 410). This determination may be made by using fuel flow metering information derived from signaling provided by a reference meter, such as the RM 54. As will be described in more detail below, costs may be decreased for an implementation of the automated calibration capabilities described herein by selecting an inferential meter for use in a flow range smaller than the entire range of operation for the fuel dispenser 10. Accordingly, there may be a desired range within which to collect data for calibration purposes. As such, a determination is made as to when the flow range is within the desired range and stable for the chosen reference meter.

Several factors can affect fluid flow stability. These factors include, for example, a presence of numerous nozzle snaps, water hammer effects, and other fluid dynamic activity within the fuel dispenser 10. An inferential reference meter may be used to detect these conditions and may accordingly be used to determine when the fuel flow is stable.

When a determination has been made that the flow rate is within range and stable, the control system 76 stores the fuel flow measurement information that may be used for calibration purposes at block 412. The fuel flow measurement information that may be stored for both meters includes, for example, information such as flow rate, volume, temperature, and viscosity of the fuel. As will be described in more detail below, the fuel flow measurement information may be stored for multiple samples to provide statistical capabilities within a calibration operation.

Additionally, when the fuel flow measurement information for multiple flow rate ranges is being stored, the fuel flow measurement information may be marked relative to the current flow rate range for the sampled information. Further, if multiple flow rate ranges are to be monitored, the control system 76 may make a determination as to which of the multiple flow rate ranges the metered fluid is currently in and may store fuel flow measurement information associated with that flow range.

Upon storage of the fuel flow measurement information (step 412), or when the flow rate is not within range and stable (decision 410), the control system 76 determines whether the dispenser transaction is complete (decision 414). When a determination is made that the dispenser transaction is not complete, the control system 76 may return to capture new fuel flow measurement data (step 404). When a determination is made that the dispenser transaction is complete, the control system 76 may return to await a new dispenser transaction (step 402).

Once the control system 76 has collected fuel flow measurement information from the meters 40, 44, 48, the control system 76 can perform the automated calibration of the PDMs 40, 44, 48. The calibration may be performed in real-time as the fuel flow measurement information is gathered, or may be performed later in time after fuel flow measurement information is gathered and stored as described in the process in FIG. 4 above.

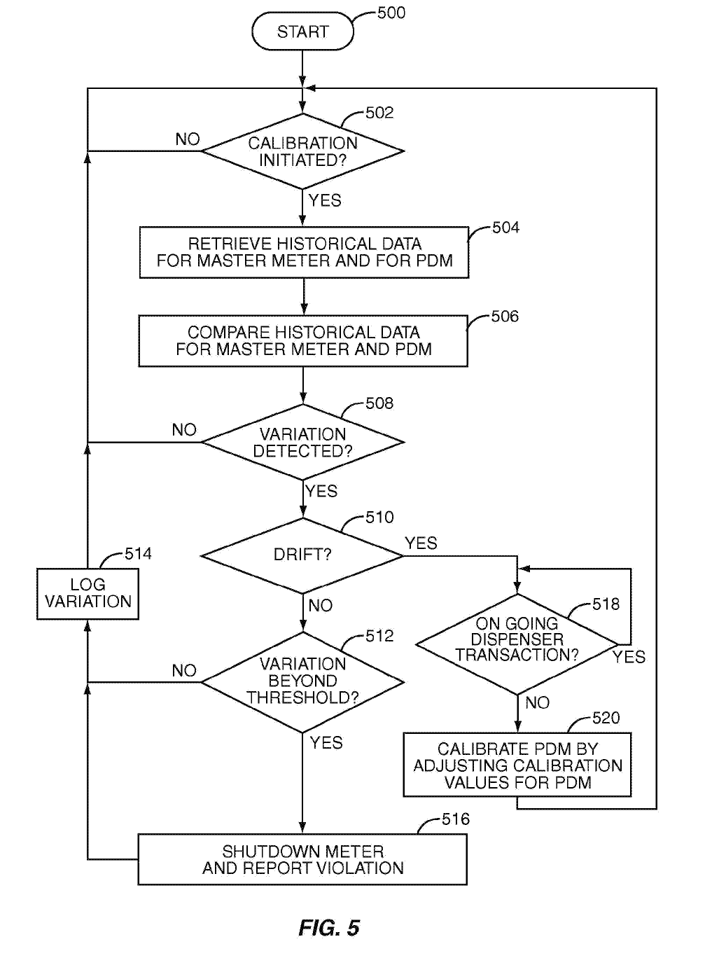

FIG. 5 illustrates an exemplary process for automated calibration of the PDMs 40, 44, 48 within the fuel dispenser 10 after fuel flow measurement information is gathered and stored. Again, the process is performed by either the control system 76 or other control system. The process described in FIG. 5 may be performed in conjunction with the process of FIG. 4 or may be a separate process. The process starts (step 500), and the control system 76 process may wait for a calibration operation to be initiated (step 502). A calibration operation may be initiated in a variety of ways. For example, a calibration operation may be initiated in a scheduled fashion. Scheduling of calibration operations may be performed at the fuel dispenser 10 in response to scheduled events that are initiated by use of configuration parameters designating calibration scheduling that may be set at installation time or at a later time. Configuration parameters may be set via the remote terminal 80 and the remote terminal 80 may also request calibration operations to be performed at the fuel dispenser 10. The remote terminal 80 may also query (not shown) the fuel dispenser 10 in order to retrieve historical metering data from the fuel dispenser 10 associated with the RM 54 and any or all of the PDMs 40, 44, 48. Accordingly, in addition to an initiation by the fuel dispenser 10, the remote terminal 80 may initiate a calibration operation by triggering a scheduling event at the fuel dispenser 10. Further, the remote terminal 80 may monitor, query, and request calibration for multiple fuel dispensers, such as the fuel dispenser 10, at a single retail site or may monitor, query, and request calibration for multiple fuel dispensers at multiple sites without departure from the scope of the subject matter described herein.

Scheduled calibration times may be selected such that the times selected for calibration operations are less likely to result in a calibration operation during a fueling transaction. A calibration operation may also occur either periodically or in response to a detection of drift or some other change in the stored data for the meters that suggests that a calibration operation may be beneficial. Additionally, a calibration operation may be initiated via a request received at the interface 78 from the remote terminal 80, either initiated by an external process or a network operator.

As a further example, the process of FIG. 5 could be initiated in response to the storage of the flow rate, volume, temperature, and viscosity for both meters within FIG. 4 at step 412. In such a case, a status flag or other indicator could be queried to determine whether a calibration operation should be performed based upon any of the indicia described above (decision 502) and, when a calibration operation is not to be initiated, the process of FIG. 4 may continue uninterrupted to determine whether the fueling transaction has completed (decision 414).

When a determination has been made that a calibration operation is to be performed (decision 502), the process retrieves historical metering data in the form of data samples that have been stored for the RM 54 and for the PDM 40, 44, 48 to be calibrated (step 504). The process compares the historical metering data for the meters at block 506. This comparison may include data samples taken since the last calibration or may include data samples taken prior to the last calibration. Further, the comparison may include comparison of data samples taken across the entirety of the stored data.

This comparison may further take the form of any statistical tool available for performing analysis on a data set in order to either determine historical trends in the data analyzed or to predict future trends. For example, variance or standard deviation calculations, time averages, and linear regressions may be performed in order to determine changes in the data stored. Additionally, predictive algorithms, like Kalman filters and various other statistical predictive tools for example, may be used to predict, when drift in the PDMs 40, 44, 48 will be beyond calibration tolerances. By use of a statistical predictive tool, a determination may be made of when the PDMs 40, 44, 48 should be replaced and a report may be generated indicating that the fuel flow meter should be scheduled for replacement. Alternatively, a repair report indicating that the PDM 40, 44, 48 needs to be serviced may be issued in order to allow maintenance or replacement of an aging PDM prior to a terminal condition within the PDM 40, 44, 48. Reports may be issued from control system 76 to a system operator associated with the remote terminal 80 via the interface 78.

Next, a determination is made based upon the chosen statistical tool and historical period over which the comparison was performed as to whether a variation has been detected across the stored data (decision 508). When a variation is not detected, the process may return to decision 502 to await a new calibration request. When a variation is detected, the process may make a determination as to whether the variation constitutes drift (decision 510).

When a determination has been made that the variation is not drift, the control system 76 makes a determination as to whether the variation is beyond a threshold variation suitable for continued operation within the fuel dispenser 10 (step 512). When a determination has been made that the variation is not beyond a suitable threshold variation and that the variation is a variation other than drift, the process may log the variation by storing a log entry including the resulting statistical analysis (step 514). This stored log entry may then become a factor used in future comparisons (step 506). In this way, the historical data set used to determine the extent of variations over time may be augmented and enhanced with each log entry. Upon entry of the variation log, the process may return to decision point 502 in order to await a new calibration request.

When a determination has been made that the variation is beyond a suitable threshold variation, the process shuts the PDM 40, 44, 48 down and issues a report indicating that a variation that is beyond the suitable threshold has occurred (step 516). As with other reporting and interface situations described above, the control system 76 may use the interface 78 to communicate with the remote terminal 80 in order to issue such a report. The control system 76 may further set a flag or create another indication, for example within the memory 124, to indicate that the affected PDM 40, 44, 48 may not be used for dispensing fuel until a repair operation has been performed. Upon performance of the repair operation, the flag may be cleared and the fuel grade may then again be dispensed by the fuel dispenser 10. When the shutdown operation and the report and flag generation are completed, the process may return to decision 502 to await another calibration request. It should be noted that no fuel will be dispensed from a meter that is shutdown. Accordingly, the control system 76 may use the previously created flag in order to avoid calibration requests for a meter that has been shutdown. Any requests that may be generated by an external process, such as a process operating at the remote terminal 80, may be responded to with an indication that the PDM 40, 44, 48 is not currently operational.

When a determination is made at decision point 510 that the variation detected at decision 508 is drift, the process initiates calibration of the PDM 40, 44, 48. The process makes a determination as to whether there is an on-going dispenser transaction in progress (decision 518). When there is an on-going dispenser transaction in progress, the process may wait until the transaction is completed. When the transaction is completed, the process calibrates the PDM 40, 44, 48 by adjusting the calibration values for the PDM 40, 44, 48 (step 520). Adjusting these calibration values may include changing an electronic calibration factor associated with the PDM 40, 44, 48 that defines the volumetric value of a pulse train generated by a rotary encoder attached to a rotating shaft within the PDM 40, 44, 48. As with other data, the calibration values for the PDMs 40, 44, 48 associated with the fuel dispenser 10 may be stored within the memory 124. Upon calibration of the PDM 40, 44, 48, the process may return to decision 502 to await another calibration request.

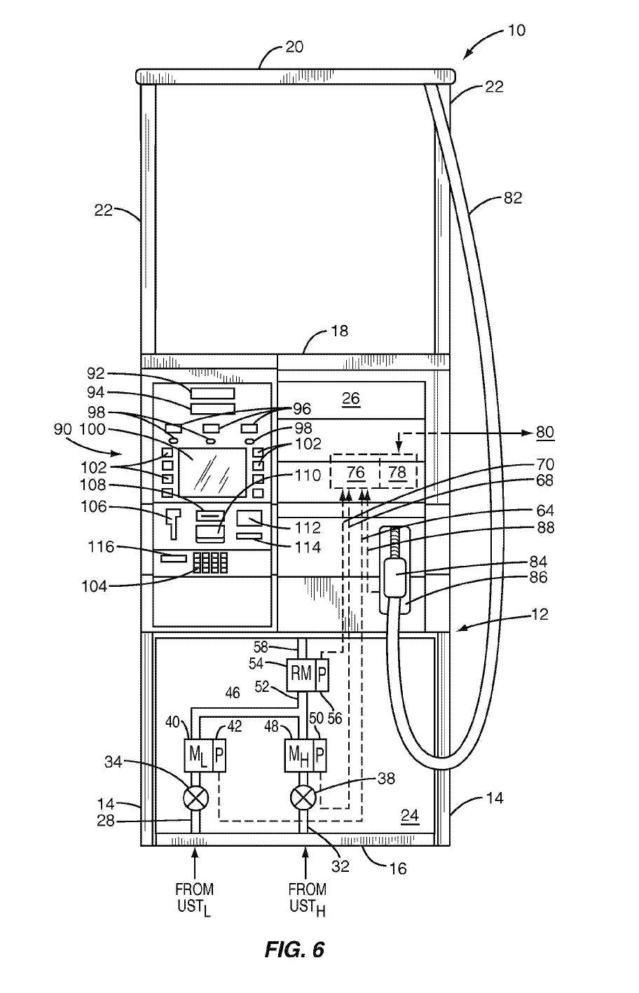

The above-described invention may also be used in conjunction with other type of dispensers, such as blending fuel dispensers for example. FIG. 6 illustrates an exemplary blending fuel dispenser capable of automated calibration of a PDM according to an embodiment of the present invention. A blended dispenser typically has all of the capabilities of a non-blended dispenser. Accordingly, the fuel dispenser 10 is redrawn within FIG. 6 to illustrate a blended dispenser embodiment. As can be seen by comparison of FIG. 2 with FIG. 6, there is no reference to an underground storage tank for medium-grade fuel. Additionally, certain components of the fuel dispenser 10 are not present within FIG. 6. The inlet pipe 30, the flow control valve 36, the PDM M_{M} 44, and the pulser 46 are not present within the blended dispenser embodiment of the fuel dispenser 10 illustrated in FIG. 6. As described above, a blended embodiment of a fuel dispenser, such as the fuel dispenser 10, may perform according to the description herein and may use either multiple meters or may use a single reference as illustrated. However, in the case of a single reference meter, statistical sampling of calibration-related data may be performed when a pure product (e.g., low-octane or high-octane) is dispensed rather than during blended transactions. Accordingly, the control system 76 may determine when a pure product is being dispensed and the process of FIG. 4 may be modified to operate when a pure product is being dispensed.

Returning to the previous description regarding use of an inferential meter as a reference meter as the RM 54, certain benefits related to inferential meters may be advantageously utilized to provide calibration capabilities for the fuel dispenser 10. For example, inferential meters do not require calibration. Accordingly, the fuel dispenser 10 may continually provide calibration capabilities for the PDM 40, 44, 48 associated with it. Statistical determinations may be used to determine whether the accuracy of a PDM is changing over time. For example, sampling over a number of dispensing transactions may be performed to determine if drift has occurred in association with the relevant PDM 40, 44, 48. When drift is detected, the calibration factor for the PDM 40, 44, 48 may be adjusted in accordance with the change in accuracy to correct for the drift within the PDM 40, 44, 48. This statistical analysis may be applied during different flow rates to correct the spread of the meter or may be applied during specific flow rate windows when the PDM 40, 44, 48 is known to have a relatively flat spread. In the latter case, the RM 54 would not be required to operate over wide flow rate ranges and may accordingly result in a less costly reference meter being suitable for use. Exemplary ranges for operation of the RM 54 may include two to five (2-5) gallons per minute (GPM), four to seven (4-7) GPM, two to ten (2-10) GPM, and any other range of operation that provides an overlapping range with the PDMs 40, 44, 48 and includes typical operating flow rates for the fuel dispenser 10.

Additionally, an inferential meter may be used to sense stability of the fluid flow through it. For example, pressure pulsations, flow fluctuations, rapid temperature swings in the metered fluid, rapid viscosity and density changes within the metered fluid, the presence of events that disturb the flow profile of the fluid such as water hammer effects associated with multiple nozzle snaps by a customer, and other related factors may all be detected by use of an inferential meter. Further, by use of an inferential meter, other problems such as a proportional valve problem may be detectable.

Because an inferential meter may be used to detect these characteristics within the fluid flowing through the meter, an inferential meter may also be used to determine when fuel flow through the inferential meter is stable. By sampling the flow characteristics within a reference meter, such as an inferential meter, for a period of time, fluid flow within both the reference meter and an active PDM may be determined to be stable for a time period sufficient to ensure that the flow is stable in both meters. The time required may vary depending upon the number of customers conducting fueling operations as well as the number of times that a customer snaps the nozzle during a fueling transaction. Flow rate stability may occur and be usable for calibration data acquisition in the range of milliseconds (e.g., three milliseconds) and up to time durations of more than a minute. Night-time dispenser transactions may occur when fewer customers are purchasing fuel. Accordingly, night-time transactions may result in longer stable periods for use during calibration data gathering phases.

It is during these detectable stable periods that data acquisition may be performed in order to provide calibration data for the PDMs 40, 44, 48. By concurrently capturing data from both the reference meter and the active PDM 40, 44, 48, metering data captured from the RM 54 may be used to provide an accurate reference measurement with which to compare the metering data captured from the active PDM 40, 44, 48.

In order to provide calibration capabilities, the RM 54 may be a fully-calibrated meter from the factory or may be calibrated initially on-site during installation. When the RM 54 is a fully-calibrated meter from the factory, it may be used to perform initial calibration of the PDMs 40, 44, 48 within the fuel dispenser 10 during the first several dispensing transactions performed. Accordingly, initial savings may be achieved by eliminating the initial costly calibration expenses associated with site start-ups. As an alternative, an initial on-site calibration may be performed, as is currently done with site start-ups. In this case, factory calibration costs associated with the RM 54 could be eliminated. Either alternative provides long-term calibration cost savings because the RM 54 may be used to perform the periodic calibration of the PDMs 40, 44, 48 within the fuel dispenser 10, as will be described in more detail below.

In addition to providing calibration capabilities within the fuel dispenser 10, the RM 54 may also provide maintenance and fraud detection. For example, if flow is registered within the RM 54 and no flow is registered within the active PDM 40, 44, 48, an error condition could be generated. This error condition could indicate either required maintenance or fraud. Further, fraud may be more difficult to perpetrate because a perpetrator would be required to defeat two meters instead of just one. Additionally, if large differences in flow rate are detected between the RM 54 and the active PDM 40, 44, 48, a hydraulic defect within the PDM 40, 44, 48 or fraudulent behavior such as a change in the calibration data for the PDM 40, 44, 48 may be detected. Wear within the active PDM 40, 44, 48 beyond acceptable calibration limits may also be detected by the RM 54. In the event that a PDM has experienced wear beyond calibration limits, a notification message may be generated to indicate that the PDM needs to be replaced. As described above, once the PDM is replaced, it may be calibrated by the RM 54 without a need for manual calibration activities.

As an additional consideration, retrofitting of existing fuel dispensers is possible. A reference meter may be placed within a fuel dispenser and appropriate fuel plumbing and circuitry may be changed in order to accommodate the reference meter.

The subject matter described herein for using a reference meter to provide automated calibration for a fuel dispenser may be implemented in hardware, software, firmware, or any combination thereof. In one embodiment, the subject matter described herein can be implemented as a computer program product including computer-executable instructions embodied in a computer-readable medium. Exemplary computer-readable media suitable for implementing the subject matter described herein includes chip memory devices, disk memory devices, programmable logic devices, application-specific integrated circuits, and downloadable electrical signals. In addition, a computer program product that implements the subject matter described herein may be located on the single device or computing platform or may be distributed across multiple devices or computing platforms.

Those skilled in the art will recognize improvements and modifications to the preferred embodiments of the present invention. All such improvements and modifications are considered within the scope of the concepts disclosed herein and the claims that follow.

What is claimed is:

1. A method of automatically calibrating a fuel flow meter in a fuel dispenser that measures fuel delivered to a vehicle, comprising the steps of:
measuring fuel flow of the fuel delivered using a fuel flow meter to form fuel flow meter measurement data;
measuring the fuel flow of the fuel delivered through the fuel flow meter using a reference meter to form reference meter measurement data;
determining whether the reference meter measurement data indicates that the fuel flow is stable and within a range of comparison;
comparing the fuel flow meter measurement data to the reference meter measurement data;
determining whether a difference exists between the fuel flow meter measurement data and the reference meter measurement data;
calibrating the fuel flow meter based on the reference meter measurement data if the difference exists between the fuel flow meter measurement data and the reference meter measurement data.
